(19) United States
(12) Patent Application Publication
(10) Pub. No.: US 2026/0164176 A1
(43) Pub. Date: Jun. 11, 2026

(54) ALIAS GENERATION FOR DEVICES

(71) Applicant: BOSE CORPORATION, Framingham, MA (US)

(72) Inventors: Somasundaram MEIYAPPAN, Chennai (IN); Thomas David CHAMBERS, Bellingham, MA (US)

(21) Appl. No.: 19/059,150

(22) Filed: Feb. 20, 2025

(30) Foreign Application Priority Data
Dec. 9, 2024 (IN) 202441097145

(51) Int. Cl. H04R 3/12; G10L 15/22; H04W 76/19

(52) U.S. Cl. CPC H04R 3/12; G10L 15/22; H04W 76/19; G10L 2015/223; H04R 2420/07

(57) ABSTRACT

Techniques, including devices and systems implementing the techniques, for using an audio device. One example audio device generally includes one or more processors. The one or more processors, individually or collectively, are generally configured to establish a wireless connection with a first source device, the first source device being associated with an identifier, generate an alias for the first source device or for a second source device, the alias being different than the identifier, and assign the alias to the first source device or the second source device. The alias of the source device may be personalized to the user (e.g., accurately express a relationship between the user and the source device) of the source device and be user and device friendly (e.g., when using large langue model based voice assistants).

### CROSS-REFERENCE TO RELATED APPLICATION

This application claims the benefit of and priority to Indian Provisional Application No. 202441097145, filed Dec. 9, 2024, which is incorporated by reference herein in its entirety.

### FIELD

Aspects of the disclosure generally relate to devices, and, more particularly to techniques and audio devices for alias generation.

### BACKGROUND

Audio devices, such as speakers and wearable devices, may utilize wireless communication to connect with source devices during audio playback. Source devices may be computing devices or user devices, and may be implemented by, for example, smartphones, personal computers, tablet computers, televisions, smart devices, broadcast devices, or wearable devices. The audio devices and/or the source devices may each be assigned and associated with an identifier that advertise the audio devices or source devices during wireless communication. Accordingly, methods for device identifier generation, as well as apparatuses and systems configured to implement these methods, are desired.

### SUMMARY

All examples and features mentioned herein can be combined in any technically possible manner.

Aspects of the present disclosure provide an audio device. The audio device generally includes one or more processors. The one or more processors, individually or collectively, are configured to: establish a wireless connection with a first source device, the first source device being associated with an identifier; generate an alias for the first source device or for a second source device, the alias being different than the identifier; and assign the alias to the first source device or the second source device.

In aspects, the one or more processors are configured, individually or collectively, to generate the alias for the first source device or for the second source device based on a user action.

In aspects, the user action includes at least one of a voice command from the user or a physical action of the user on the first source device or the second source device.

In aspects, the one or more processors are configured, individually or collectively, to generate the alias for the first source device or for the second source device based on information associated with the first source device or on information associated with the second source device.

In aspects, the information associated with the first source device or the information associated with the second source device includes at least one of a vendor ID (VID) or a product ID (PID), and the one or more processors are configured, individually or collectively, to generate the alias for the first source device or for the second source device based on the information associated with the first source device or the information associated with the second source device by comparing at least one of at least a portion of the VID or at least a portion of the PID to a database.

In aspects, the one or more processors are configured, individually or collectively, to assign the alias to the first source device or the second source device without any action from the user.

In aspects, the one or more processors are further configured, individually or collectively, to: generate a plurality of aliases including the alias; and provide the plurality of aliases to the user, and the one or more processors are configured, individually or collectively, to assign the alias to the first source device or the second source device based on an action of the user that selects the alias from among the plurality of aliases.

In aspects, the plurality of aliases further includes at least one of a smartphone alias, a tablet computer alias, a personal computer alias, a television alias, a smart device alias, a broadcast device alias, or a wearable device alias.

In aspects, the one or more processors are configured, individually or collectively, to generate the plurality of aliases based on information from one or more other audio devices.

In aspects, the one or more processors are further configured, individually or collectively, to: terminate the wireless connection with the first source device; after a period of time, re-establish the wireless connection with the first source device; and announce, using one or more speakers included in the audio device, the alias for the first source device when the wireless connection is re-established.

In aspects, the one or more processors are further configured, individually or collectively, to least one of: un-assign the alias after a period of time; or un-assign the alias in response to an action of the user.

In aspects, the one or more processors are further configured, individually or collectively, to synchronize the alias across one or more other audio devices linked to the user.

In aspects, the one or more processors are further configured, individually or collectively, to: terminate the wireless connection with the first source device; and in response to a voice command including at least part of the alias for the first source device, re-establish the wireless connection with the first source device.

In aspects, the audio device includes a wearable device.

Aspects of the present disclosure are directed to a method of using an audio device. The method generally includes establishing a wireless connection with a first source device, the first source device being associated with an identifier, generating an alias for the first source device or for a second source device, the alias being different than the identifier, and assigning the alias to the first source device or the second source device.

In aspects, generating the alias for the first source device or for the second source device is based on an action of a user of the audio device.

In aspects, generating the alias for the first source device or for the second source device is based on information associated with the first source device or on information associated with the second source device.

Aspects of the present disclosure provide a non-transitory computer-readable medium including computer-executable instructions that, when executed by one or more processors of a wearable device, cause the wearable device to perform a method. The method generally includes establishing a wireless connection with a first source device, the first source device being associated with an identifier, generating an alias for the first source device or for a second source device, the alias being different than the identifier, and assigning the alias to the first source device or the second source device.

In aspects, generating the alias for the first source device or for the second source device is based on an action of the user.

In aspects, generating the alias for the first source device or for the second source device is based on information associated with the first source device or on information associated with the second source device.

Two or more features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 illustrates an example system, in which aspects of the present disclosure may be implemented.

FIG. 2 illustrates another example system, in which aspects of the present disclosure may be implemented.

FIG. 3A illustrates an exemplary sound processing and playback device, in which aspects of the present disclosure may be implemented.

FIG. 3B illustrates an exemplary source device, in which aspects of the present disclosure may be implemented.

FIG. 4 illustrates example operations for alias generation, in accordance with certain aspects of the present disclosure.

FIGS. 5A-5E illustrate example user interfaces during the alias generation of FIG. 4, according to certain aspects of the present disclosure.

### DETAILED DESCRIPTION

Certain aspects of the present disclosure provide techniques, including devices and systems implementing the techniques, for alias generation. Such techniques may involve generating an alias for a source device (e.g., a device, such as a smartphone, personal computer, tablet computer, television, smart device, broadcast device, wearable device, and the like) and assigning the alias to the source device. In some cases, the alias may be generated and assigned to the source device before any wireless communications have been established between the source device and an audio device. In other cases, the alias may be generated and assigned to the source device after wireless communications have been established between the source device and the audio device. The alias may be an alias specific to a user of the source device and based on information associated with the user or the source device itself, in contrast to typical source device identifiers that may be used to advertise the source device during wireless communication. As a result, the alias may be better personalized to a user of the source device (e.g., more accurately express a relationship between the user and the source device) and be more user and device friendly (e.g., easier for the user to hear or read and simpler for the source device and/or the audio device to display or announce), compared to typical source device identifiers.

Often times, when an audio device wirelessly connects to a source device, the audio device may audibly announce the identifier (e.g., name) of the source device. For example, a pair of headphones may wirelessly connect to a smartphone, and the headphones may output the identifier of the smartphone to indicate the wireless connection. The identifier may, for example, be automatically generated by the source device in accordance with certain naming conventions, or assigned by information technology (IT) personnel. The content of the identifier of the source device may be, for example, a large string of characters (e.g., letters, numbers, punctuation, and/or spaces) that advertise the source device, or may be some combination of a name of the user and a designation of the source device. However, these wireless communication identifiers are often and long and cumbersome, and frequently lack sufficient user personalization. This is especially problematic and confusing when there are a myriad of source devices and associated identifiers available for the audio device to choose to wireless connect with. As a result, these device identifiers may have limited utility for the users of the devices and may not be user friendly. For example, a device identifier may not clearly inform the user of the device of the identity of the device, and the device identifier may be difficult for the user to use in a voice command and/or for the device to clearly and intelligibly announce (e.g., due to being long and/or hard to articulate).

The present disclosure may enable the generation of an alias for the source device, which may replace or be used in conjunction with the identifier of the device. The alias may be selectable by the user or even automatically assigned, and may also be always modifiable by the user of the source device, using, for example, physical affordances and/or voice commands. The alias may also accurately and concisely express the user's relationship (or the relationship of an audio device of the user) with the source device, based on information associated with the user or the source device itself. In some cases, the alias may be synchronized across other devices (e.g., source devices and/or audio devices) associated with the user. The alias may further be practical and easily usable by the user and the device during interactions (e.g., interactions using physical affordances and/or voice commands) between the user and the source device. As such, the alias may be simpler, more personalized, and more convenient than the device identifier, and thus more useful to the device user. The alias may be especially beneficial in audio devices and source devices using large langue model (LLM)-based voice assistants, to better describe the source device and more easily provide the user with control of the source device (e.g., by using the source device alias).

### An Example System

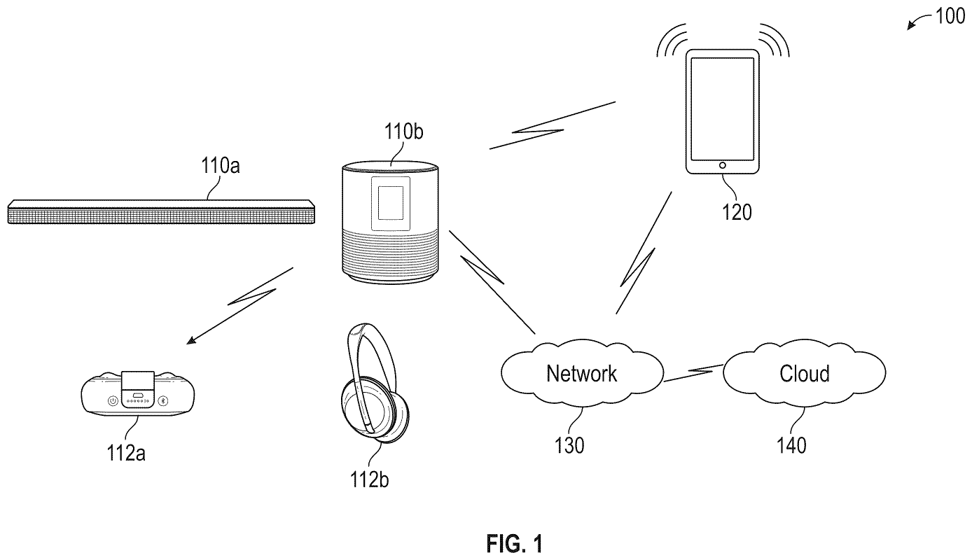

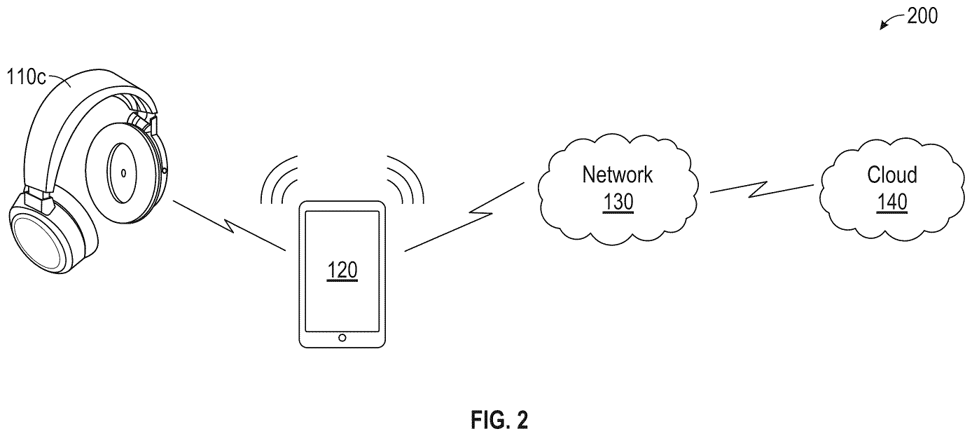

FIG. 1 illustrates an example system 100, in which aspects of the present disclosure may be implemented. As shown, system 100 includes one or more sound processing and playback devices 110 (e.g., a wireless audio device, such as a sound bar 110a, a speaker or smart speaker 110b, a wearable device 110c (shown in FIG. 2), and the like, collectively referred to herein as a sound processing and playback device 110) communicatively coupled with a source device 120 (e.g., a computing device or user device, such as a smartphone, tablet computer, personal computer, television, smart device, broadcast device, wearable device, and the like). Throughout the present disclosure, the sound processing and playback device 110 may be referred to simply as the device 110. In the example of FIG. 1, the device 110 is shown implemented as both a sound bar 110a and a speaker or smart speaker 110b. One or more partner devices 112 (e.g., a portable speaker 112a, a headset 112b, and the like, collectively referred to herein as partner device 112) may be available to accept pairing requests from the device 110 or the source device 120. The device 110 may be paired with the source device 120 and may receive content data (including audio signal(s)) from the source device 120. The device 110 may also receive content data directly from the network 130. The partner device 112 may be battery-powered portable devices suitable for mobile or privacy applications.

The device 110 may include hardware and circuitry including processor(s)/processing system and memory configured to implement one or more sound management capabilities or other capabilities including, but not limited to, noise cancelling circuitry (not shown) and/or noise masking circuitry (not shown), body movement detecting devices/sensors and circuitry (e.g., one or more accelerometers, one or more gyroscopes, one or more magnetometers, etc.), geolocation circuitry and other sound processing circuitry. The noise cancelling circuitry is configured to reduce unwanted ambient sounds external to the device 110 by using active noise cancelling (also known as active noise reduction). The sound masking circuitry is configured to reduce distractions by playing masking sounds via the speakers of the device 110. The movement detecting circuitry is configured to use devices/sensors such as an accelerometer, gyroscope, magnetometer, and the like to detect whether the user wearing the device 110 is moving (e.g., walking, running, in a moving mode of transport, etc.) or is at rest and/or the direction the user is looking or facing. The movement detecting circuitry may also be configured to detect a head position of the user for use in determining an event, as will be described herein, as well as in augmented reality (AR) applications where an AR sound is played back based on a direction of gaze of the user.

In certain aspects, the device 110 may be wirelessly connected to the source device 120 or the partner devices 112 using one or more wireless communication methods including, but not limited to, Bluetooth, Wi-Fi, Bluetooth Low Energy (BLE), other radio frequency (RF) based techniques, and the like. In certain aspects, the device 110 includes a transceiver that transmits and receives data via one or more antennae in order to exchange audio data and other information with the source device 120.

In certain aspects, the device 110 includes communication circuitry capable of transmitting and receiving audio data and other information from the source device 120. The device 110 also includes an incoming audio buffer, such as a render buffer, that buffers at least a portion of an incoming audio signal (e.g., audio packets) in order to allow time for retransmissions of any missed or dropped data packets from the source device 120. For example, when the device 110 receives Bluetooth transmissions from the source device 120, the communication circuitry typically buffers at least a portion of the incoming audio data in the render buffer before the audio is actually rendered and output as audio to at least one of the transducers (e.g., audio speakers) of the device 110. This is done to ensure that even if there are RF collisions that cause audio packets to be lost during transmission, that there is time for the lost audio packets to be retransmitted by the source device 120 before they have to be rendered by the device 110 for output by one or more acoustic transducers of the device 110.

One example of the partner device 112 is shown as noise-canceling headphones; however, the techniques described herein apply to other wireless audio devices, such as wearable audio devices, including any audio output device that fits around, on, in, or near an ear (including open-ear audio devices worn on the head or shoulders of a user) or other body parts of a user, such as head or neck. The partner device 112 may take any form, wearable or otherwise, including standalone alone devices (including automobile speaker system), stationary devices (including portable devices, such as battery powered portable speakers), headphones, earphones, earpieces, headsets, goggles, headbands, earbuds, armbands, sport headphones, neckband, hearing aids, or eyeglasses with integrated speaker(s).

In certain aspects, the device 110 is connected to the source device 120 using a wired connection, with or without a corresponding wireless connection. The source device 120 can be a smartphone, tablet computer, personal computer, television, smart device, broadcast device, wearable device, a digital camera, or other user device that connects with the device 110. As shown, the source device 120 can be connected to a network 130 (e.g., the Internet) and can access one or more services over the network. As shown, these services can include one or more cloud 140 services.

In certain aspects, the source device 120 can access a cloud server in the cloud 140 over the network 130 using a mobile web browser or a local software application or “app” executed on the source device 120. In certain aspects, the software application or “app” is a local application that is installed and runs locally on the source device 120. In certain aspects, a cloud server accessible on the cloud 140 includes one or more cloud applications that are run on the cloud server. The cloud application can be accessed and run by the source device 120. For example, the cloud application can generate web pages that are rendered by the mobile web browser on the source device 120. In certain aspects, a mobile software application installed on the source device 120 or a cloud application installed on a cloud server, individually or in combination, may be used to implement the techniques for low latency Bluetooth communication between the source device 120 and the device 110 in accordance with aspects of the present disclosure. In certain aspects, examples of the local software application and the cloud application include a gaming application, an audio AR application, and/or a gaming application with audio AR capabilities. The source device 120 may receive signals (e.g., data and controls) from the device 110 and send signals to the device 110.

FIG. 2 illustrates another example system 200, in which aspects of the present disclosure may be implemented. In the example of FIG. 2, the sound processing and playback device 110 is shown implemented as a wearable device 110c configured to be worn by a user, and may be a headset that includes two or more speakers, as illustrated in FIG. 2. At a high level, the device 110 may play audio content transmitted from the source device 120. The user may use the graphical user interface (GUI) on the source device 120 to select the audio content and/or adjust settings of the device 110. The device 110 provides soundproofing, active noise cancellation, and/or other audio enhancement features to play the audio content transmitted from the source device 120.

The device 110 is illustrated in FIG. 2 as over-the-head headphones; however, the techniques described herein apply to other wearable devices, such as wearable audio devices, including any audio output device that fits around, on, in, or near an ear (including open-ear audio devices worn on the head or shoulders of a user) or other body parts of a user, such as head or neck. The wearable device 110 may take any form, wearable or otherwise, including standalone devices (including automobile speaker system), stationary devices (including portable devices, such as battery powered portable speakers), headphones (including over-ear headphones, on-ear headphones, in-ear headphones), earphones, earpieces, headsets (including virtual reality (VR) headsets and AR headsets), goggles, headbands, earbuds, armbands, sport headphones, neckbands, hearing aids, or eyeglasses.

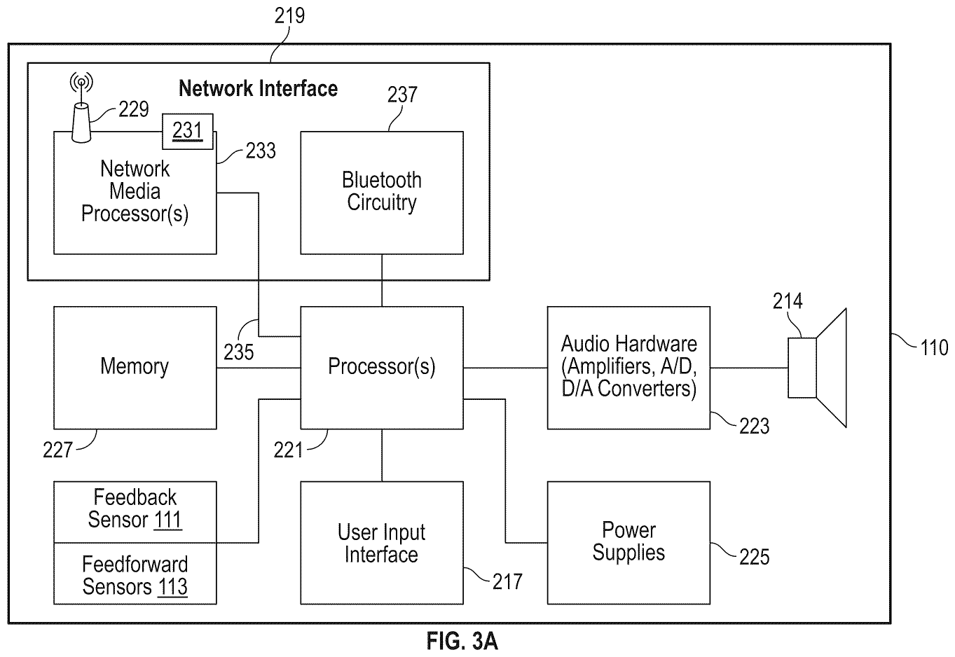

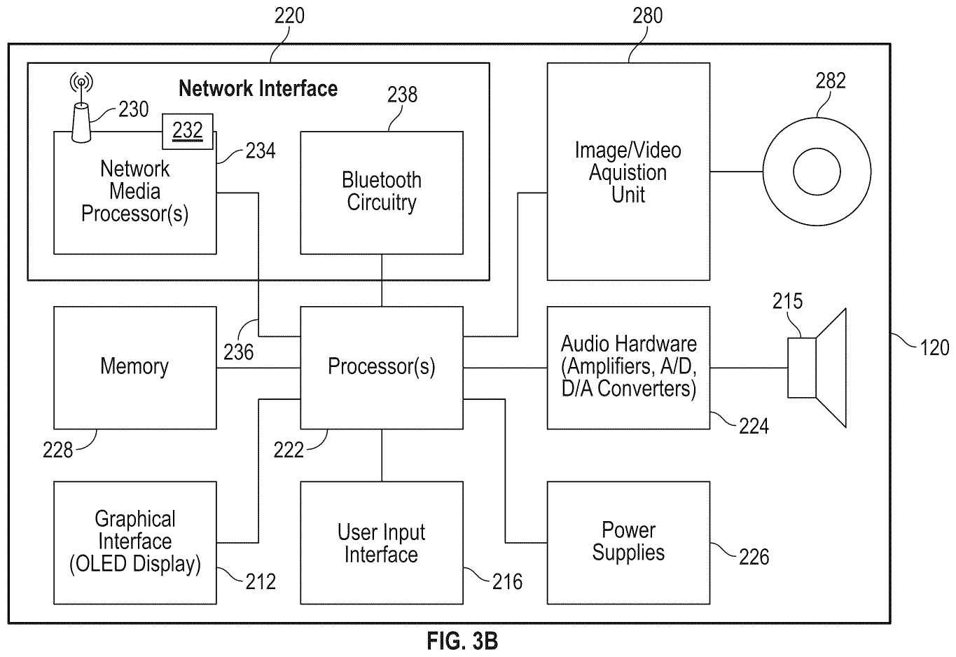

FIG. 3A illustrates an exemplary device 110 and some of its components. Other components may be inherent in the device 110 and not shown in FIG. 3A. For example, the device 110 may include an enclosure that houses an optional graphical interface (e.g., an organic light-emitting diode (OLED) display) which can provide the user with information regarding currently playing (“Now Playing”) music. In certain aspects, the partner device 112 may include components illustrated in FIG. 3A and described above.

The device 110 may include one or more electro-acoustic transducers (e.g., an acoustic driver or speaker) 214 for outputting audio. The device 110 may also include a user input interface 217. The user input interface 217 may include a plurality of preset indicators, which may be hardware buttons. The preset indicators may provide the user with easy, one press access to entities assigned to those buttons. The assigned entities may be associated with different ones of the digital audio sources such that a single device 110 may provide for single press access to various different digital audio sources.

The device 110 may include a feedback sensor 111 and feedforward sensor(s) 113. The feedback sensor 111 and the feedforward sensor(s) 113 may include two or more microphones for capturing ambient sound and provide audio signals for determining location attributes of events. The transmission delays may be used to reduce errors in subsequent computation. The feedforward sensor(s) 113 may provide two or more channels of audio signals. The audio signals are captured by microphones that are spaced apart and may have different directional responses. The two or more channels of audio signals may be used for calculating directional attributes of an event of interest.

As shown in FIG. 3A, the device 110 may include one or more electro-acoustic transducers (e.g., an acoustic driver or speaker) 214 to transduce audio signals to acoustic energy through audio hardware 223. The the device 110 also may include a network interface 219, at least one processor 221, the audio hardware 223, power supplies 225 for powering the various components of the the device 110, and memory 227. In certain aspects, the processor(s) 221, the network interface 219, the audio hardware 223, the power supplies 225, and the memory 227 are interconnected using various buses 235, and several of the components can be mounted on a common motherboard or in other manners as appropriate. In some cases, the at least one processor(s) 221 may be included in a controller.

The network interface 219 provides for communication between the the device 110 and other electronic computing devices via one or more communications protocols, such as Bluetooth classic protocol, Bluetooth low energy protocol, and others. The network interface 219 provides either or both of a wireless network interface 229 and a wired interface 231. The wireless network interface 229 allows the the device 110 to communicate wirelessly with other devices in accordance with a wireless communication protocol such as IEEE 802.11. The wired interface 231 provides network interface functions via a wired (e.g., Ethernet) connection for reliability and fast transfer rate, for example, used when the the device 110 is not worn by a user. Although illustrated, the wired interface 231 is optional.

In certain aspects, the network interface 219 includes at least one network media processor 233 for supporting Apple AirPlay® and/or Apple Airplay® 2. For example, if a user connects an AirPlay® or Apple Airplay® 2 enabled device, such as an iPhone or iPad device, to the network, the user can then stream music to the network connected audio playback devices via Apple AirPlay® or Apple Airplay® 2. Notably, the audio playback device can support audio-streaming via AirPlay®, Apple Airplay® 2 and/or Digital Living Network Alliance's (DLNA) Universal Plug and Play (UPnP) protocols, all integrated within one device.

All other digital audio received as part of network packets may pass straight from the at least one network media processor 233 through a universal serial bus (USB) bridge (not shown) to the processor(s) 221 and runs into the decoders, DSP, and eventually is played back (rendered) via the electro-acoustic transducer(s) 214.

The network interface 219 can further include Bluetooth circuitry 237 for Bluetooth applications (e.g., for wireless communication with a Bluetooth enabled audio source such as a smartphone or tablet) or other Bluetooth enabled speaker packages. In certain aspects, the Bluetooth circuitry 237 may be the primary network interface 219 due to energy constraints. For example, the network interface 219 may use the Bluetooth circuitry 237 solely for mobile applications when the wearable device 210 adopts any wearable form. For example, BLE technologies may be used in the wearable device 210 to extend battery life, reduce package weight, and provide high quality performance without other backup or alternative network interfaces.

In certain aspects, the network interface 219 supports communication with other devices using multiple communication protocols simultaneously at one time. For instance, the the device 110 can support Wi-Fi/Bluetooth coexistence and can support simultaneous communication using both Wi-Fi and Bluetooth protocols at one time. For example, the the device 110 can receive an audio stream from a smart phone using Bluetooth and can further simultaneously redistribute the audio stream to one or more other devices over Wi-Fi. In certain aspects, the network interface 219 may include only one RF chain capable of communicating using only one communication method (e.g., Wi-Fi or Bluetooth) at one time. In this context, the network interface 219 may simultaneously support Wi-Fi and Bluetooth communications by time sharing the single RF chain between Wi-Fi and Bluetooth, for example, according to a time division multiplexing (TDM) pattern.

Streamed data may pass from the network interface 219 to the processor(s) 221. The processor(s) 221 may execute instructions (e.g., for performing, among other things, digital signal processing, decoding, and equalization functions), including instructions stored in the memory 227. The processor(s) 221 may be implemented as a chipset of chips that includes separate and multiple analog and digital processors. The processor(s) 221 may provide, for example, for coordination of other components of the the device 110, such as control of user interfaces.

The memory 227 may store software/firmware related to protocols and versions thereof used by the device 110 for communicating with other networked devices, including the source device 120. For example, the software/firmware governs how the device 110 communicates with other devices for synchronized playback of audio. In certain aspects, the software/firmware includes lower level frame protocols related to control path management and audio path management. The protocols related to control path management generally include protocols used for exchanging messages between speakers. The protocols related to audio path management generally include protocols used for clock synchronization, audio distribution/frame synchronization, audio decoder/time alignment, and playback of an audio stream. In certain aspects, the memory can also store various codecs supported by the speaker package for audio playback of respective media formats. In certain aspects, the software/firmware stored in the memory can be accessible and executable by the processor(s) for synchronized playback of audio with other networked speaker packages.

In certain aspects, the protocols stored in the memory 227 may include BLE according to, for example, the Bluetooth Core Specification Version 5.2 (BT5.2). The the device 110 and the various components therein are provided herein to sufficiently comply with or perform aspects of the protocols and the associated specifications. For example, BT5.2 includes enhanced attribute protocol (EATT) that supports concurrent transactions. A new L2CAP mode is defined to support EATT. As such, the the device 110 may include hardware and software components sufficiently to support the specifications and modes of operations of BT5.2, even if not expressly illustrated or discussed in this disclosure. For example, the device 110 may utilize LE Isochronous Channels specified in BT5.2.

The processor(s) 221 provides a processed digital audio signal to the audio hardware 223 which includes one or more digital-to-analog (D/A) converters for converting the digital audio signal to an analog audio signal. The audio hardware 223 also includes one or more amplifiers which provide amplified analog audio signals to the electro-acoustic transducer(s) 214 for sound output. In addition, the audio hardware 223 may include circuitry for processing analog input signals to provide digital audio signals for sharing with other devices, for example, other speaker packages for synchronized output of the digital audio.

The memory 227 can include, for example, flash memory and/or non-volatile random-access memory (NVRAM). In certain aspects, instructions (e.g., software) are stored in an information carrier. The instructions, when executed by one or more processing devices (e.g., the processor(s) 221), perform one or more processes, such as those described elsewhere herein. The instructions can also be stored by one or more storage devices, such as one or more computer or machine-readable mediums (for example, the memory 227, or memory on the processor(s)). The instructions can include instructions for performing decoding (i.e., the software modules include the audio codecs for decoding the digital audio streams), as well as digital signal processing and equalization. In certain aspects, the memory 227 and the processor(s) 221 may collaborate in data acquisition and real time processing with the feedback sensor 111 and feedforward sensor(s) 113.

FIG. 3B illustrates an exemplary source device 120, such as a smartphone or a mobile computing device, in accordance with certain aspects of the present disclosure. Some components of the source device 120 may be inherent and not shown in FIG. 3B. For example, the source device 120 may include an enclosure. The enclosure may house an optional graphical interface 212 (e.g., an OLED display), as shown. The graphical interface 212 provides the user with information regarding currently playing (“Now Playing”) music or video. The source device 120 includes one or more electro-acoustic transducers 215 for outputting audio. The source device 120 may also include a user input interface 216 that enables user input.

The source device 120 also includes a network interface 220, at least one processor 222, audio hardware 224, power supplies 226 for powering the various components of the source device 120, and a memory 228. In certain aspects, the processor(s) 222, the graphical interface 212, the network interface 220, the audio hardware 224, the one or more power supplies 226, and the memory 228 are interconnected using the one or more buses 236, and several of the components can be mounted on a common motherboard or in other manners as appropriate. In certain aspects, the processor(s) 222 of the source device 120 is more powerful in terms of computation capacity than the processor(s) 221 of the the device 110. Such difference may be due to constraints of weight, power supplies, and other requirements. Similarly, the power supplies 226 of the source device 120 may be of a greater capacity and heavier than the power supplies 225 of the the device 110. In some cases, the at least one processor(s) 222 may be included in a controller.

The network interface 220 provides for communication between the source device 120 and the device 110, as well as other audio sources and other wireless speaker packages including one or more networked wireless speaker packages and other audio playback devices via one or more communications protocols. The network interface 220 can provide either or both of a wireless network interface 230 and a wired interface 232. The wireless network interface 230 allows the source device 120 to communicate wirelessly with other devices in accordance with a wireless communication protocol, such as IEEE 802.11. The wired interface 232 provides network interface functions via a wired (e.g., Ethernet) connection.

In certain aspects, the network interface 220 may also include at least one network media processor 234 and Bluetooth circuitry 238, similar to the at least one network media processor 233 and Bluetooth circuitry 237 in the device 110 in FIG. 3A. Further, in aspects, the network interface 220 supports communication with other devices using multiple communication protocols simultaneously at one time, as described with respect to the network interface 219 in FIG. 3A.

All other digital audio received as part of network packets comes straight from the at least one network media processor 234 through one or more buses 236 (e.g., USB bridge) to the at least one processor 222 and runs into the decoders, DSP, and eventually is played back (rendered) via the electro-acoustic transducer(s) 215.

The source device 120 may also include an image or video acquisition unit 280 for capturing image or video data. For example, the image or video acquisition unit 280 may be connected to one or more cameras 282 and capable of capturing still or motion images. The image or video acquisition unit 280 may operate at various resolutions or frame rates according to a user selection. For example, the image or video acquisition unit 280 may capture 4K videos (e.g., a resolution of 3840 by 2160 pixels) with the one or more cameras 282 at 30 frames per second, full high definition (FHD) videos (e.g., a resolution of 1920 by 1080 pixels) at 60 frames per second, or a slow motion video at a lower resolution, depending on hardware capabilities of the one or more cameras 282 and the user input. The one or more cameras 282 may include two or more individual camera units having respective lenses of different properties, such as focal length resulting in different fields of views. The image or video acquisition unit 280 may switch between the two or more individual camera units of the cameras 282 during a continuous recording.

Captured audio or audio recordings, such as the voice recording captured at the device 110, may pass from the network interface 220 to the processor(s) 222. The processor(s) 222 executes instructions within the wireless speaker package (e.g., for performing, among other things, digital signal processing, decoding, and equalization functions), including instructions stored in the memory 228. The processor(s) 222 can be implemented as a chipset of chips that includes separate and multiple analog and digital processors. The processor(s) 222 can provide, for example, for coordination of other components of the audio source device 120, such as control of user interfaces and applications. The processor(s) 222 provides a processed digital audio signal to the audio hardware 224 similar to the respective operation by the processor(s) 221 described in FIG. 3A.

The memory 228 can include, for example, flash memory and/or NVRAM. In certain aspects, instructions (e.g., software) are stored in an information carrier. The instructions, when executed by one or more processing devices (e.g., the processor(s) 222), perform one or more processes, such as those described herein. The instructions can also be stored by one or more storage devices, such as one or more computer or machine-readable mediums (for example, the memory 228, or memory on the processor(s) 222). The instructions can include instructions for performing decoding (i.e., the software modules include the audio codecs for decoding the digital audio streams), as well as digital signal processing and equalization.

### Example Operations for Alias Generation

Certain aspects of the present disclosure provide techniques, including devices and systems implementing the techniques, for alias generation. The alias generation may be performed by, for example, an audio device of a user. The alias generation may involve, for example, generating an alias for a source device that is wireless connected to an audio device. In another example, the alias generation may involve generating an alias for a source device that was previously wirelessly connected to an audio device, or to a source device that is available for wireless connection to the audio device. The alias generation herein may provide a source device alias that is simpler, more personalized, and more convenient than typical source device identifiers, and thus more useful to the audio device user when selecting which source device to connect to (e.g., to receive and accept an audio signal associated with a movie, television show, sport event, game, music, podcast, or other similar entertainment). The alias generation may be especially useful when users frequently use the same source devices, by saving the user time during each interaction between the audio device and the source device.

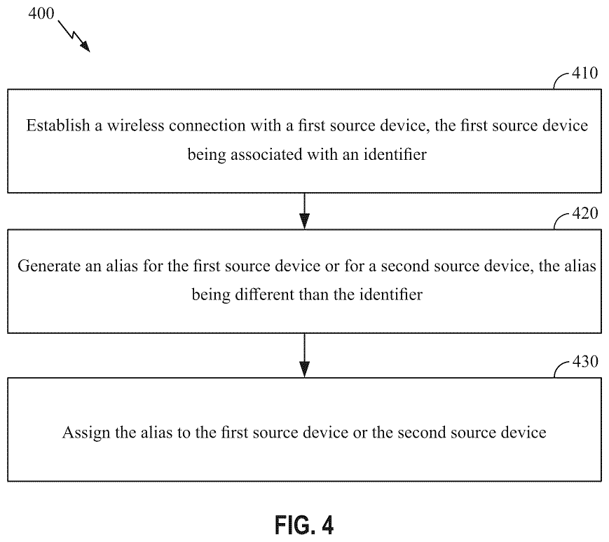

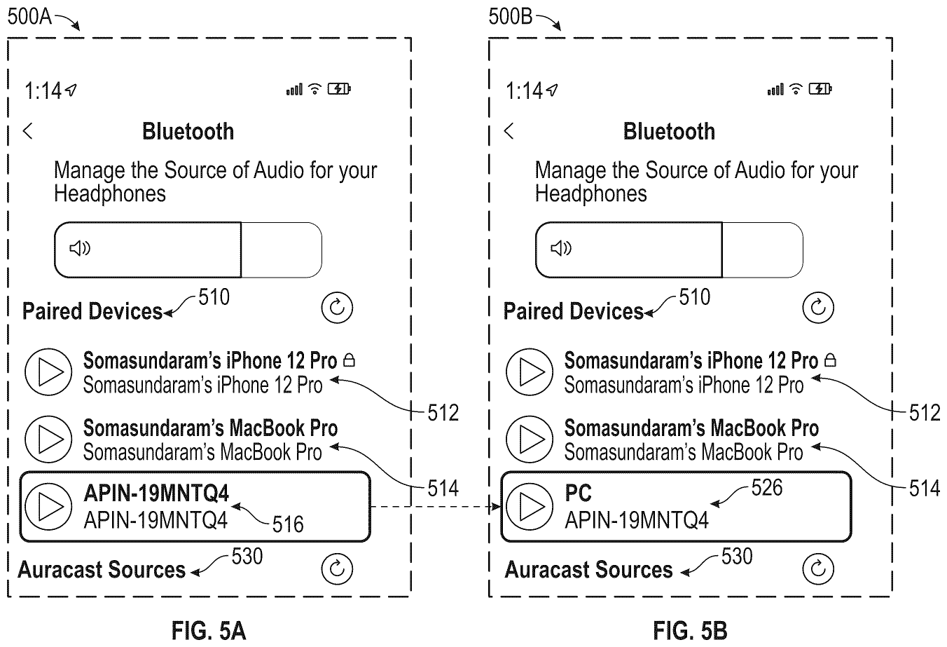

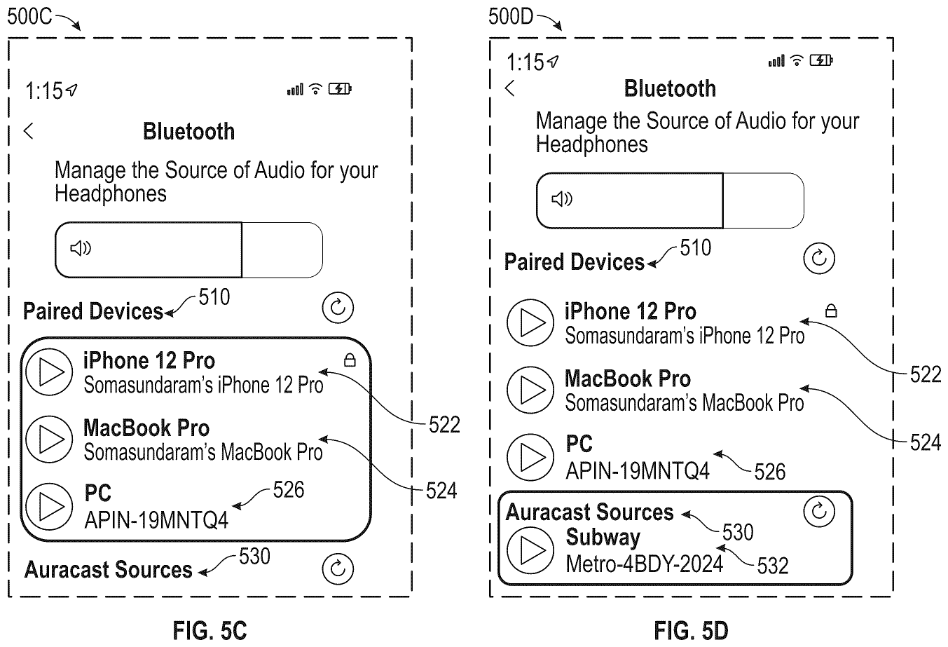

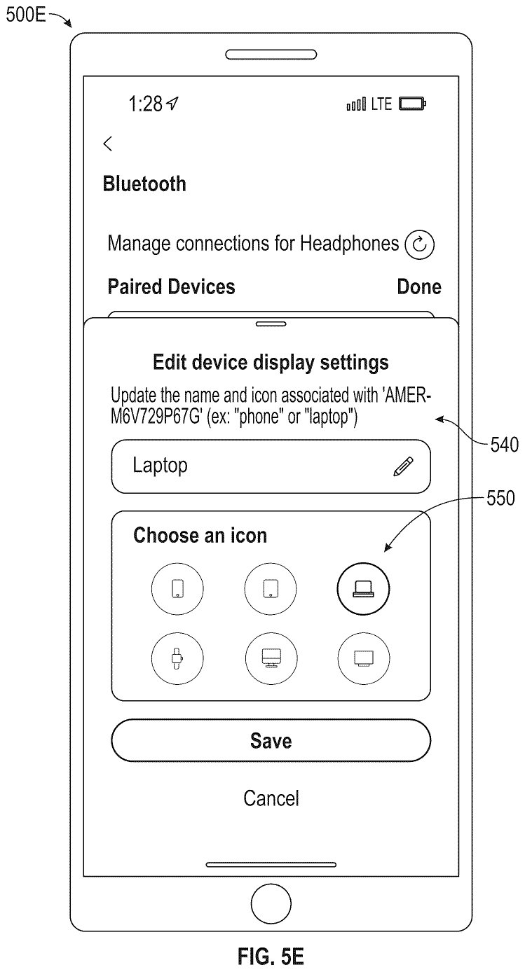

FIG. 4 illustrates example operations 400 for alias generation, in accordance with certain aspects of the present disclosure. FIGS. 5A-5E illustrate example user interfaces 500A-500E during the alias generation of FIG. 4, according to certain aspects of the present disclosure. Therefore, FIGS. 4 and 5A-5E are herein described together for clarity.

The operations 400 may be performed by a device (e.g., the audio device 110 of FIG. 1 and FIG. 2, which may be implemented as, for example, a sound bar, a speaker, or a smart speaker, a wearable device, and the like, or an accessory device, such as the source device 120, which may be implemented as, for example, a smartphone, tablet computer, personal computer, television, smart device, broadcast device, wearable device, and the like). For example, the operations 400 may be performed by the at least one processor(s) 221 included in the device 110 implemented as a speaker system (e.g., as illustrated in FIG. 1) or as a wearable device (e.g., as illustrated in FIG. 2). In this example, the speaker may be implemented in the device. In another example, the operations 400 may be performed by the at least one processor(s) 222 included in the source device 120 (e.g., as illustrated in FIG. 1). In this example, the speaker may be implemented in a different device (e.g., a speaker system) that is in communication with and configured to be controlled by the source device 120. When multiple processor(s) 221 or processor(s) 222, the multiple processor(s) 221 or the multiple processor(s) 222 may perform the operations 400 individually or collectively. In certain aspects, the device may be associated with or be used by a user.

The operations 400 may include, at block 410, establishing a wireless connection with a first source device (e.g., the source device 120, which may be implemented as, for example, a smartphone, tablet computer, personal computer, television, smart device, broadcast device, wearable device, and the like). In some cases, the first source device may be an Auracast audio device. The audio device may establish a wireless connection with the first source device to facilitate audio playback from the first source device through the audio device. In some cases, after the audio device may receive and accept an audio signal (e.g., an audio signal associated with a movie, television show, sport event, game, music, podcast, or other similar entertainment) from the first source device. For example, the user of an audio device may wish to listen to music from a smartphone, and may direct the audio device to establish a wireless communication with the first source device (e.g., using a physical affordance and/or a voice command). The wireless connection may be, for example, Bluetooth, Wi-Fi, Bluetooth Low Energy (BLE), other radio frequency (RF) based techniques, and the like. The broadcast device (e.g., broadcast source or service) described herein may be an audio transmitter, such as a smartphone, laptop, television, or public address system, configured to broadcast audio to an unlimited number of nearby receivers, including speakers, earbuds, or hearing devices. The broadcast devices may be implemented as, for example, Auracast audio device (e.g., source) and the like. Some examples of broadcast devices may be a television at a hotel room or public gathering space, a speaker system at a lecture hall gym, airport, train station, hotel or lounge, or a speaker system on public transportation (e.g., train, bus, subway, airplane, and the like).

In certain aspects, the first source device may be associated with an identifier. The identifier may be used, for example, to advertise the first source device during wireless communications. As described above, the source device identifier (e.g., name) may be automatically generated by the first source device in accordance with certain naming conventions, or assigned by information technology (IT) personnel. The identifier may, for example, be automatically generated by the source device in accordance with certain naming conventions, or assigned by information technology (IT) personnel. The content of the identifier of the source device may be, for example, a large string of characters (e.g., letters, numbers, punctuation, and/or spaces) that advertise the source device, or may be some combination of a name of the user and a designation of the source device. However, these wireless communication identifiers are often and long and cumbersome, and frequently lack sufficient user personalization. This is especially problematic and confusing when there are a myriad of source devices and associated identifiers available for the audio device to choose to wireless connect with. As a result, these device identifiers may have limited utility for the users of the devices and may not be device friendly. For example, a device identifier may not clearly inform the user of the device of the identity of the device, and the device identifier may be difficult for the user to use in a voice command and/or for the device to clearly and intelligibly announce (e.g., due to being long and/or hard to articulate).

At block 420, the operations 400 may include generating an alias for the first source device or for a second source device (e.g., another source device 120, which may be implemented as, for example, a smartphone, tablet computer, personal computer, television, smart device, broadcast device, wearable device, and the like). In some cases, the second source device may be an Auracast audio device. The alias may be different than the identifier, and may be more personalized to the user as well as more user and device friendly (e.g., easier for the user to understand when heard or read and easier for the source device and/or the audio device to display or announce), as described above. It is to be understood that any combination of the techniques for generating the alias for the first source device or for a second source device at block 420 may be used jointly or individually. The aliases generated at block 420 may be stored on the audio device, the first source device, the second source device, and/or online in the cloud. The alias generated may, in some examples, be stored in cloud storage associated with an account of the user of the audio device.

In aspects where the alias is generated for the first source device, the audio device may have established a wireless connection (e.g., in block 410). In aspects where the alias is generated for the second source device, the audio device may have not established a wireless connection with the second source device and may be available for a wireless connection, or may have previously established a wireless connection with the second source device that has already been terminated. In this manner, generating of the alias for the first source device or for a second source device at block 420 may be for source devices with an active wireless connection with the audio device, as well as for source devices without an active wireless connection with the audio device.

In certain aspects, generating the alias for the first source device or for the second source device at block 420 may be based on a user action. The user action may include at least one of a voice command from the user or a physical action of the user on the first source device or the second source device. In some cases, the user may issue a voice command to generate the alias (or revise the alias) for the first source device or for the second source device, either in response to a voice prompt from the audio device (e.g., a voice prompt resulting from the beginning of a wireless connection with the first source device, or resulting from the availability of a wireless connection with the second source device) or without any prompting. For example, the user may command the audio device to cause the alias (or revise an alias) of the first source device (which may be, for example, the user's smartphone) to be “my phone.” In this manner, the user may generate the alias for the first source device without any physical affordances on an interface (e.g., an application run on the first source device). In other cases, the user may perform a physical action on the audio device and/or the first source device (e.g., manipulation of an actuatable control feature on the device, such as a button or dial, or an affordance on the audio device and/or the first source device) to cause the alias of the first source device (which may be, for example, the user's smartphone) to be “my phone.”

Referring to FIG. 5A and in some scenarios, the user interface 500A may display, for example, identifiers 512 (“Somasundaram's iPhone”), 514 (“Somasundaram's MacBook Pro”), and 516(“APIN-19MNTQ 4”) under Paired Devices 510. The user interface 500A may be displayed, for example, on the first source device (e.g., implemented as the user's smartphone). The source devices associated with identifiers 512, 514, and 516 may be currently wireless connected, previously wireless connected, or available to wirelessly connect to the audio device. The user interface 500A may also display Auracast Sources 530 (which may include Auracast audio devices or other broadcast devices). As illustrated in user interface 500A, identifiers 512 and 514 may be long and therefore difficult to read and say (especially when utilizing voice commands and LLM-based voice assistants on the audio device or the source device), while the identifier 516 may be a long string of characters that fails to easily identify the associated source device. The techniques for alias generation described herein may generate personalized aliases for the source devices associated with identifiers 512, 514, and 516.

Referring to FIG. 5B, and as illustrated in user interface 500B, identifier 516 has been changed to alias 526 (“PC”), which more clearly identifies the source device associated with alias 526 and the user's relationship with the source device and is also easier to read (e.g., on the interface) and hear (e.g., when used by an LLM-based voice assistant). Referring to FIG. 5C, and as illustrated in user interface 500C, identifiers 512 and 514 have been changed to aliases 522 and 524 (“iPhone 12 Pro” and “MacBook Pro,” respectively), which more clearly identify the source devices associated with aliases 522 and 524 and are also shorter and therefore quicker and easier to read and hear. The previous identifiers 512, 514, and 516 may, in some cases, be displayed along with alias 522, alias 524, and alias 526, as illustrated.

Referring to FIG. 5D, and as illustrated in user interface 500D, Auracast Sources 530 may include alias 532 (“Subway”) associated with an Auracast audio device. Referring to FIG. 5E, and as illustrated in user interface 500E, the user may be able to generate or update the alias in a textbox 540 via a touchscreen keyboard. The user may also be able to select an icon associated with the Paired Device 510 or the Auracast Sources 530.

In certain aspects, generating the alias for the first source device or for the second source device at block 420 may be based on information associated with the first source device or on information associated with the second source device. In this manner, the alias may be inferred using the information associated with the first source device or on information associated with the second source device. The information may include, for example, one or more of a product name or model (e.g., iPhone, Galaxy, MacBook, Galaxy Book, etc.), or brand (e.g., Apple, Samsung, Microsoft, iPhone, Galaxy, etc.). The information may also include, for example, a name or nickname of a user of the device. In some cases, the information associated with the first source device or the information associated with the second source device may include at least one of a vendor ID (VID) or a product ID (PID). In these cases, generating the alias for the first source device or for the second source device at block 420 may involve comparing at least one of at least a portion of the VID or at least a portion of the PID to a database. The database may include known VID and PID information from a wide variety of source devices, such that the VID and/or PID information of the first source device or for the second source device may be easily compared, correlated, and matched (e.g., using a trained machine-learning model). In this manner, the product name, model, or brand of the first source device or for the second source device (along with other pertinent information) may be determined from the VID and the PID information, even if the product name, model, brand, or other information about first source device or for the second source device is not easily apparent from the VID and the PID information or other information advertised by the first source device or for the second source device.

In certain aspects, generating the alias for the first source device or for the second source device at block 420 may involve using a trained machine-learning model. The trained machine-learning models described herein may be pre-trained before operation of the device 110, and may be implemented by deep learning models, and/or may be trained during the operations 400 or other operations performed by the device 110. The trained machine-learning models may use various machine learning techniques based on artificial neural networks. For example, when implemented as a deep learning model, the trained machine-learning model may include deep learning architectures, such as deep neural networks, deep belief networks, deep reinforcement learning, recurrent neural networks, convolutional neural networks, transformers, and the like. Utilizing the trained machine-learning model may, for example, enable more efficient and accurate comparison of the at least one of at least a portion of the VID or at least a portion of the PID to the database.

In certain aspects, generating the alias for the first source device or for the second source device at block 420 may be performed without any user action. In some cases, information from the user or other users (and their respective audio devices and/or source devices) who have previously wirelessly connected to the first source device or the second source device or to similar source devices may be used to generate the alias for the first source device or for the second source device at block 420 (for example, with a trained machine-learning model) without any user action. In this manner, aliases for source devices may be crowd-sourced, to enable previously generated aliases to be carried over and assigned to the source devices when used by future users. In some cases, when previous users have connected to a broadcast device and generated an alias for that broadcast device, that alias may be crowd-sourced such that the alias is used for future users with audio devices that wireless connect to the broadcast device. For example, when an alias for a subway sound system has been generated (e.g., “Subway”) by one user, that alias may be assigned to the subway sound system for another user, without having to perform all of the operations 400. As such, popular broadcast devices may be associated with aliases both for past and for present users who may wirelessly connect audio devices to the broadcast devices.

According to certain aspects, the operations 400 may further include (i) generating one or more aliases (which may be, for example, a plurality of aliases) that includes the alias that will be assigned at block 430, and (ii) providing the one or more aliases to the user. In these aspects, the operations 400 may further include assigning the alias to the first source device or the second source device based on an action of the user that selects the alias from among the one or more aliases. In some cases, the plurality of aliases includes a list of generally popular or typical aliases, and/or aliases that are determined (e.g., using a trained machine-learning model) to be probable options for the particular user of the device that may be suggested to the user. For example, the list of aliases may include at least one of a smartphone alias, a tablet computer alias, a personal computer alias, a television alias, a smart device alias, a broadcast device alias, or a wearable device alias. The list of aliases may prioritize the most common source devices for the user at the beginning (e.g., smartphone, personal computer) of the list. It is to be understood that any number of aliases may be generated in the list of aliases. In some cases, the one or more aliases may be suggestions and the user may be prompted to select a preferred alias from the one or more aliases (e.g., using a physical affordance and/or voice command), whereas in other cases, the most likely alias (e.g., determined using a trained machine-learning model and/or the history of the user) in the plurality of aliases may be automatically suggested without user interaction.

In certain aspects, the generating of the plurality of aliases may be based on information from one or more other audio devices. In some cases, the information may be information from the user or other users (and their respective audio devices) who have previously wirelessly connected to the first source device, the second source device, or to similar source devices to assist in determining (e.g., with a trained machine-learning model) the one or more aliases.

At block 430, the operations 400 may include assigning the alias to the first source device or the second source device. In certain aspects, the generated alias may be automatically assigned to the first source device or the second source device at block 430 without any user action. In other aspects, the user may be prompted to confirm the generated alias at block 420 before assigning the alias to the first source device or the second source device at block 430.

According to certain aspects, the operations 400 may further include, after block 430, (i) terminating the wireless connection with the first source device, (ii) after a period of time, re-establishing the wireless connection with the first source device, and (iii) announcing, using one or more speakers included in the audio device (e.g., electro-acoustic transducers 214), the alias for the first source device when the wireless connection is re-established. In this manner, the personalized alias for the first source device generated and assigned at blocks 420 and 430 may be used to announce any future wireless connection to the first source device (instead of the identifier of the first source device). The personalized alias for the second source device generated and assigned at blocks 420 and 430 may likewise be used to announce any future wireless connection to the second source device (instead of the identifier of the second source device).

According to certain aspects, the operations 400 may further include un-assigning the alias in response to an action of the user (e.g., a physical affordance and/or a voice command). For example, the user may direct the audio device (or the source device itself) to un-assign the alias from the first source device or the second source device. When not un-assigned by the user, the alias may remain permanent. After being unassigned, the alias may additionally be deleted and no longer stored.

In some cases, the alias may be automatically un-assigned the alias after a period of time. The period of time may be configured by the user (e.g., using a physical affordance and/or a voice command) or predetermined by the audio device. The period of time may be different for various types of sources devices, such that aliases may be unassigned after different periods of times depending on the type of source device (e.g., smartphone, personal computer, tablet computer, television, smart device, broadcast device, wearable device, and the like). For example, source devices implemented as smartphones may be unassigned after one year (e.g., because the audio device is more likely to repeatedly connect to the smartphone over a long period of time), whereas source devices implemented as broadcast devices may be unassigned after one day (e.g., because the audio device may only utilize a broadcast device or service for a short period of time while visiting the area). In another example, the television in a hotel room may be assigned the alias “Hotel TV” when the user is staying in the hotel room. In this example, the alias may be automatically un-assigned after a period of time (e.g., a few days or until the user is no longer staying in the hotel room), as the user may only benefit from the alias while staying in the hotel room with the television.

In certain aspects, the generated alias may be un-assigned when the audio device reaches a certain distance from the source device associated with the alias. For example, when an alias is generated for a hotel room television, and the user reaches a certain number of miles or kilometers from the hotel room television, the audio device may infer that the user no longer plans to wireless connect to the hotel room television, and the audio device may un-assign and delete the alias (e.g., to save storage space).

According to certain aspects, the operations 400 may further include synchronizing the alias across one or more other audio devices linked to the user. In this manner, the alias generated at block 420 for the first source device or the second source device may be associated with the user and may be consistent across any audio devices associated with the user, saving the user from having to expend effort to carry over aliases between different audio devices. For example, after a source device is assigned to an alias (e.g., “my TV”) by the audio device (e.g., headphones) of the user, that source device may be known by that alias for other audio devices (e.g., smart speaker) of the user that are associated with the user (e.g., through a user account).

According to certain aspects, the operations 400 may further include terminating the wireless connection with the first source device, and in response to a voice command including at least part of the alias for the first source device, re-establishing the wireless connection with the first source device. In this manner, the personalized alias generated and assigned at blocks 420 and 430 may be remembered by the audio device and used by the user in the future to direct the audio device to re-establish wireless connection with the first source device (instead of using the identifier of the first source device).

It is to be understood that the operations described herein may be applied to generating and assigning an alias to the any source device (including the first source device and the second source device), the audio device, and/or to other audio devices as well. It is also to be understood that in some cases, generate and assign aliases for the first source device and the second source device during the operations 400.

### Additional Considerations

It is noted that, descriptions of aspects of the present disclosure are presented above for purposes of illustration, but aspects of the present disclosure are not intended to be limited to any of the disclosed aspects. Many modifications and variations will be apparent to those of ordinary skill in the art without departing from the scope and spirit of the described aspects.

In the preceding, reference is made to aspects presented in this disclosure. However, the scope of the present disclosure is not limited to specific described aspects. Aspects of the present disclosure can take the form of an entirely hardware aspect, an entirely software aspect (including firmware, resident software, micro-code, etc.) or an aspect combining software and hardware aspects that can all generally be referred to herein as a “component,” “circuit,” “module” or “system.” Furthermore, aspects of the present disclosure can take the form of a computer program product embodied in one or more computer readable medium(s) having computer readable program code embodied thereon.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples of a computer readable storage medium include: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium can be any tangible medium that can contain, or store a program. For example, the computer readable storage medium can contain, for example, computer-executable instructions that, when executed by one or more processors of a device, individually or collectively, cause the device to perform the operations described herein.

The flowchart and block diagrams in the Figures illustrate the architecture, functionality and operation of possible implementations of systems, methods and computer program products according to various aspects. In this regard, each block in the flowchart or block diagrams can represent a module, segment or portion of code, which comprises one or more executable instructions for implementing the specified logical function(s). In some alternative implementations the functions noted in the block can occur out of the order noted in the figures. For example, two blocks shown in succession can, in fact, be executed substantially concurrently, or the blocks can sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

What is claimed is:

1. An audio device of a user comprising:
one or more processors being configured, individually or collectively, to:
establish a wireless connection with a first source device, the first source device being associated with an identifier;
generate an alias for the first source device or for a second source device, the alias being different than the identifier; and
assign the alias to the first source device or the second source device.

2. The audio device of claim 1, wherein the one or more processors are configured, individually or collectively, to generate the alias for the first source device or for the second source device based on a user action.

3. The audio device of claim 2, wherein the user action comprises at least one of a voice command from the user or a physical action of the user on the first source device or the second source device.

4. The audio device of claim 1, wherein the one or more processors are configured, individually or collectively, to generate the alias for the first source device or for the second source device based on information associated with the first source device or on information associated with the second source device.

5. The audio device of claim 4, wherein the information associated with the first source device or the information associated with the second source device comprises at least one of a vendor ID (VID) or a product ID (PID), and wherein the one or more processors are configured, individually or collectively, to generate the alias for the first source device or for the second source device based on the information associated with the first source device or the information associated with the second source device by comparing at least one of at least a portion of the VID or at least a portion of the PID to a database.

6. The audio device of claim 4, wherein the one or more processors are configured, individually or collectively, to assign the alias to the first source device or the second source device without any action from the user.

7. The audio device of claim 1, wherein the one or more processors are further configured, individually or collectively, to:
generate a plurality of aliases including the alias; and
provide the plurality of aliases to the user, wherein the one or more processors are configured, individually or collectively, to assign the alias to the first source device or the second source device based on an action of the user that selects the alias from among the plurality of aliases.

8. The audio device of claim 7, wherein the plurality of aliases further includes at least one of a smartphone alias, a tablet computer alias, a personal computer alias, a television alias, a smart device alias, a broadcast device alias, or a wearable device alias.

9. The audio device of claim 7, wherein the one or more processors are configured, individually or collectively, to generate the plurality of aliases based on information from one or more other audio devices.

10. The audio device of claim 1, wherein the one or more processors are further configured, individually or collectively, to:
terminate the wireless connection with the first source device;
after a period of time, re-establish the wireless connection with the first source device; and
announce, using one or more speakers included in the audio device, the alias for the first source device when the wireless connection is re-established.

11. The audio device of claim 1, wherein the one or more processors are further configured, individually or collectively, to least one of:
un-assign the alias after a period of time; or
un-assign the alias in response to an action of the user.

12. The audio device of claim 1, wherein the one or more processors are further configured, individually or collectively, to synchronize the alias across one or more other audio devices linked to the user.

13. The audio device of claim 1, wherein the one or more processors are further configured, individually or collectively, to:
terminate the wireless connection with the first source device; and
in response to a voice command including at least part of the alias for the first source device, re-establish the wireless connection with the first source device.

14. The audio device of claim 1, wherein the audio device comprises a wearable device.

15. A method of using an audio device, the method comprising:
establishing a wireless connection with a first source device, the first source device being associated with an identifier;
generating an alias for the first source device or for a second source device, the alias being different than the identifier; and
assigning the alias to the first source device or the second source device.

16. The method of claim 15, wherein generating the alias for the first source device or for the second source device is based on an action of a user of the audio device.

17. The method of claim 15, wherein generating the alias for the first source device or for the second source device is based on information associated with the first source device or on information associated with the second source device.

18. A non-transitory computer-readable medium comprising computer-executable instructions that, when executed by one or more processors of an audio device of a user, cause the audio device to perform a method, the method comprising:
establishing a wireless connection with a first source device, the first source device being associated with an identifier;
generating an alias for the first source device or for a second source device, the alias being different than the identifier; and
assigning the alias to the first source device or the second source device.

19. The non-transitory computer-readable medium of claim 18, wherein generating the alias for the first source device or for the second source device is based on an action of the user.

20. The non-transitory computer-readable medium of claim 18, wherein generating the alias for the first source device or for the second source device is based on information associated with the first source device or on information associated with the second source device.
